(19) United States
(12) Patent Application Publication
(10) Pub. No.: US 2006/0046103 A1
(43) Pub. Date: Mar. 2, 2006

(54) Method for producing magnetic recording medium and magnetic recording medium

(75) Inventor: Hiromichi Itoh, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/214,821

(22) Filed: Aug. 31, 2005

(30) Foreign Application Priority Data
Aug. 31, 2004 (JP) P.2004-252260

(51) Int. Cl. B05D 5/12

(52) U.S. Cl. 428/838; 427/127

(57) ABSTRACT

It is to provide such a method for producing a magnetic recording medium that can prevent deterioration in quality and decrease in yield due to stress caused by thermal contraction of a support roll and thermal expansion of a winding core, and a magnetic recording medium produced thereby. The method for producing a magnetic recording medium contains a step of winding a support on a winding core to form a support roll, the following relationship being satisfied:
200≧54,000/D+0.007 L+10⁶α wherein D represents an outer diameter (mm) of the winding core, L represents a wound length (m) of the support, and a represents a linear expansion coefficient (per ° C.) in a circumferential direction of the winding core.

This application is based on Japanese Patent application JP 2004-252260, filed Aug. 31, 2004, the entire content of which is hereby incorporated by reference. This claim for priority benefit is being filed concurrently with the filing of this application.

### BACKGROUND OF THE INVENTION

1. Technical Field of the Invention

The present invention relates to a method for producing a magnetic recording medium and a magnetic recording medium, and more particularly, to such a magnetic recording medium that can prevent the magnetic recording medium from being deformed by influence of a heat treatment upon production, and a magnetic recording medium.

2. Description of the Related Art

FIGS. 4A to 4C are diagrams showing a production process of a magnetic recording medium. As shown in FIG. 4A, while a support 51 in a strip form is conveyed from a raw material roll, in a coating part 41, a magnetic layer is coated on one surface of the support 51 with a magnetic layer coating member 42, and a backcoat layer is coated on the other surface thereof. The support 51 having the magnetic layer coated thereon is wound on a support winding part 43. Subsequently, as shown in FIG. 4B, the support 51 is supplied from the support winding part 43 to a calender part 45 and is conveyed among plural calender rolls 44 provided in the calender part 45. At this time, the support 51 is passed through nips among the calender rolls 44 to improve the smoothness of the surface of the magnetic layer on the support 51. The support 51 is then wound on a winding core 52 to form a support roll 46 (as described, for example, in JP-A-2000-285445 and JP-A-6-295436). Thereafter, as shown in FIG. 4C, the support roll 46 is subjected to a heat treatment by allowing it stand in an environmental atmosphere 47 set at a prescribed temperature (which has been conventionally in a range about from 60 to 70° C.) for a period of from 30 to 50 hours. Upon producing a magnetic tape, for example, the support roll 46 having been subjected to a heat treatment is slit in the longitudinal direction with a slitter in a slitting step to produce a magnetic tape having a prescribed tape width.

However, in the related art production method of a magnetic recording medium, in the heat treatment shown in FIG. 4C, the support roll 46 suffers thermal contraction, and the winding core 52 suffers thermal expansion, whereby a stress is applied to the sheets of the wound support of the support roll 46 due to deformations caused by thermal contraction of the support 51 and thermal expansion of the winding core 52. As a result, there are cases where the surface of the magnetic layer having been smoothened by the calendering step is deformed by pressing onto the backcoat layer having a rough surface to increase the surface roughness (Ra). The increase in surface roughness (Ra) is conspicuous on the side of the winding core and becomes severe by increasing the turn number (winding number) of the support. The difference in surface roughness (Ra) depending on inside and outside the roll causes fluctuation in quality of a magnetic tape, such as errors, depending on inside and outside of the roll.

Furthermore, there are cases where deformation and crease along the peripheral direction, which are referred to as cylindrical buckling, shown in FIG. 5, and deformation and crease along the axial direction S, which are referred to as cinching, as in a support roll 56 shown in FIG. 6, occur due to thermal contraction in the heat treatment. In the case where the support roll 46 suffers cylindrical buckling or cinching, output variation occurs, and the dimensional accuracy in width of the magnetic tape slit in the slitting step is deteriorated to fail to follow a head upon recording servo signals or reproducing, which brings about tracking errors.

Furthermore, in the case where the winding core suffers large thermal expansion, the raw material is liable to cause habit of unevenness in thickness due to the heat treatment, whereby the magnetic tape suffers large dynamic curvature or change in polarity (direction) of static curvature on the way of winding. Therefore, there are such possibilities that the appearance of the roll of the magnetic tape wound on a tape reel is deteriorated, and the edges of the magnetic tape are damaged.

Accordingly, it has been demanded that thermal expansion of a winding core is prevented from occurring upon subjecting a support roll 46 to a heat treatment, whereby the support is prevented from being increased in surface roughness Ra or from being deformed.

### SUMMARY OF THE INVENTION

The invention has been made under the circumstances, and an object thereof is to provide such a method for producing a magnetic recording medium that prevents a support roll from being deformed in the production process to attain uniform quality and improvement of quality of the product, and is also to provide a magnetic recording medium produced by the method.

The aforementioned and other objects of the invention are attained by the following constitutions.

(1) A method for producing a magnetic recording medium containing a step of winding a support on a winding core to form a support roll, the following relationship being satisfied:
200≧54,000/D+0.007 L+10⁶α
wherein D represents an outer diameter (mm) of the winding core, L represents a wound length (m) of the support, and α represents a linear expansion coefficient (per ° C.) in a circumferential direction of the winding core.

(2) The method for producing a magnetic recording medium as described in (1), wherein the winding core is made of a material having a linear expansion coefficient in the circumferential direction of 5×10⁻⁶ or less, and a Young's modulus in the circumferential direction of 8,000 kg/mm² or more.

(3) The method for producing a magnetic recording medium as described in (1) or (2), wherein the material of the winding core is CFRP.

(4) The method for producing a magnetic recording medium as described in one of (1) to (3), wherein the support roll is subjected to a heat treatment in an environmental atmosphere having a temperature of 50° C. or more.

(5) A magnetic recording medium produced by the method for producing a magnetic recording medium as described in one of (1) to (4).

According to the invention, the influence of thermal expansion of the winding core is avoided in the production process, whereby the support roll can be prevented from being applied with an excessive stress, and the increase in surface roughness (Ra) of the magnetic layer by pressing the magnetic layer to the backcoat layer can be prevented from occurring, so as to provide uniform quality of the product. In the case where CFRP is used as a material of the winding core, the stress applied to the support due to thermal expansion and contraction of the winding core in the thermal treatment can be reduced, whereby upon producing a magnetic tape, the linearity of the tape can be prevented from being deteriorated to prevent tracking errors from occurring. Furthermore, the thermal contraction ratio can be reduced, whereby cylindrical buckling and cinching of the support can be prevented from occurring, the appearance of the roll of the magnetic tape wound on a tape reel is prevented from being deteriorated, and the quality and yield of the magnetic tape are improved.

### BRIEF DESCRIPTION OF THE DRAWINGS

FIG. 1 is a diagram showing a state where a calendered support is wound on a winding core.

FIG. 2 is a diagram showing the winding core, on which the support in FIG. 1 is wound.

FIG. 3 is a diagram showing the heat-treating step of the support roll in an embodiment.

FIGS. 4A to 4C are diagrams showing a production process of a magnetic recording medium.

FIG. 5 is a diagram showing a state where a support roll suffers cylindrical buckling.

FIG. 6 is a diagram showing a state where a support roll suffers cinching.

### DETAILED DESCRIPTION OF THE INVENTION

An embodiment of the invention will be described with reference to the drawings. A method for producing a magnetic recording medium according to the embodiment contains a coating step of coating and forming a magnetic layer containing ferromagnetic powder and a binder on one surface of a support in a long strip form; a coating step of coating and forming a backcoat layer on a surface of the support opposite to the magnetic layer; a calendering step of subjecting the support having the magnetic layer and the backcoat layer formed thereon to a calendering treatment; a heat-treating step of subjecting the calendered support to a heat treatment; and a slitting step of slitting the calendered support in the longitudinal direction, The method may further contain a servo step after the slitting step. In this embodiment, the coating steps and the calendering step can be carried out according to the conventional production method.

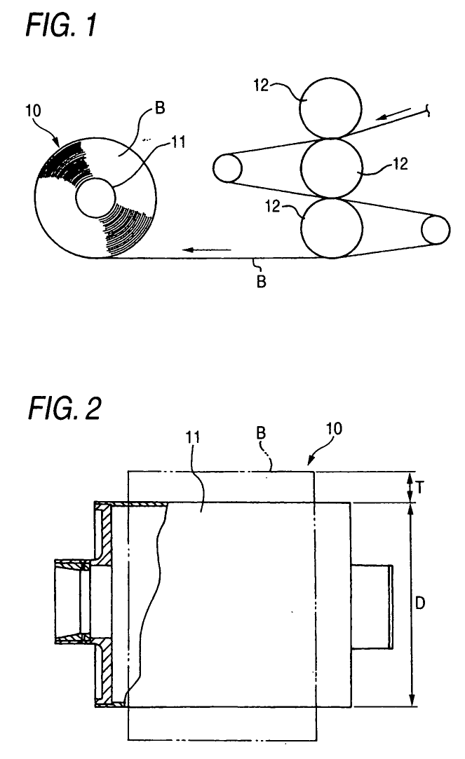

FIG. 1 is a diagram showing a state where a calendered support is wound on a winding core. FIG. 2 is a diagram showing the winding core, on which the support in FIG. 1 is wound. As shown in FIG. 1, the support B having been subjected to a calendering treatment with the calender rolls 12 in the calendering step is wound on the outer peripheral surface of the cylindrical winding core 11 to form a support roll 10.

As shown in FIG. 2, the winding core 11 has a cylindrical main body, and the support B is repeatedly wound on the peripheral surface of the main body to constitute the support roll. The winding core 11 has supporting axes for supporting the main body rotationally in the peripheral direction thereof, the supporting axes being extended in the axial direction from both side plates of the main body. The winding core is not limited in structure. For example, the winding core may have a reinforcing member inside, such as ribs, and the cylindrical part thereof may have a double layer structure.

In this embodiment, the winding core 11 has an outer diameter D of 400 mm or more, and the support B has a thickness t of 5 μm or more. The thickness t of the support B can be obtained by the equation t=T/n, wherein n represents the number of winding of the support B on the winding core 11, and T represents the total thickness of the support B wound on the winding core 11. The length L of the support B wound on the winding core 11 in the embodiment satisfies the equation 1,000 m≦L≦12,000 m, but the length L of the support is not limited to the range.

In this embodiment, furthermore, carbon fiber reinforced plastics (CFRP) are used as a material for constituting the winding core 11. As the material of the winding core, such a material that has a linear expansion coefficient (per ° C.) of 5×10⁻⁶ or less can be used, and for example, LEX (a trade name, produced by Nippon Chuzo Co., Ltd.) can be used.

In the case where the winding core 11 is constituted by the aforementioned material, it is preferred that the main body and the side plates are formed with the same material for suppressing thermal deformation due to difference in linear expansion coefficient. A member formed with a material having a low thermal expansion coefficient on the outer periphery may be formed as a detachable sleeve. The winding core may have an appearance of cylindrical shape or crown shape satisfying 50 μm/R. The material of the winding core preferably has a Young's modulus of 8,000 kg/mm² or more in the circumferential direction for excluding efficiently accompanying air upon winding to prevent cylindrical buckling from occurring.

The inventors have found that in the case where the parameters are set to satisfy the equation 200≧54,000/D+0.007 L+10⁶α, upon subjecting the support B to a heat treatment, thermal expansion of the winding core 11 is reduced, and the stress caused by thermal contraction of the support B is suppressed, whereby the magnetic layer of the support B can be prevented from being pressed onto the backcoat layer thereof. According to the constitution, the surface roughness (Ra) of the magnetic layer can be prevented from being increased.

Furthermore, the inventors have also found that in the case where the winding core 11 is constituted by such a material that has a linear expansion coefficient of 5×10⁻⁶ or less and a Young's modulus of 8,000 kg/mm² or more, upon subjecting the support roll 10 to a heat treatment, cylindrical buckling and cinching can be prevented from occurring. Accordingly, such problems can be prevented from occurring as output variation on reproduction, and deterioration in dimensional accuracy in width of the magnetic tape slit in the slitting step, which brings about failure in following a head upon recording servo signals or reproducing to cause tracking errors,

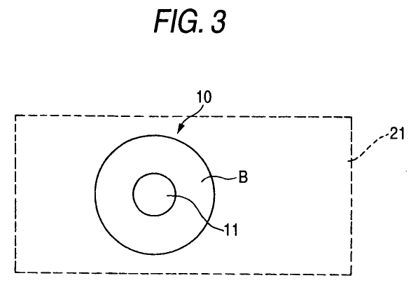

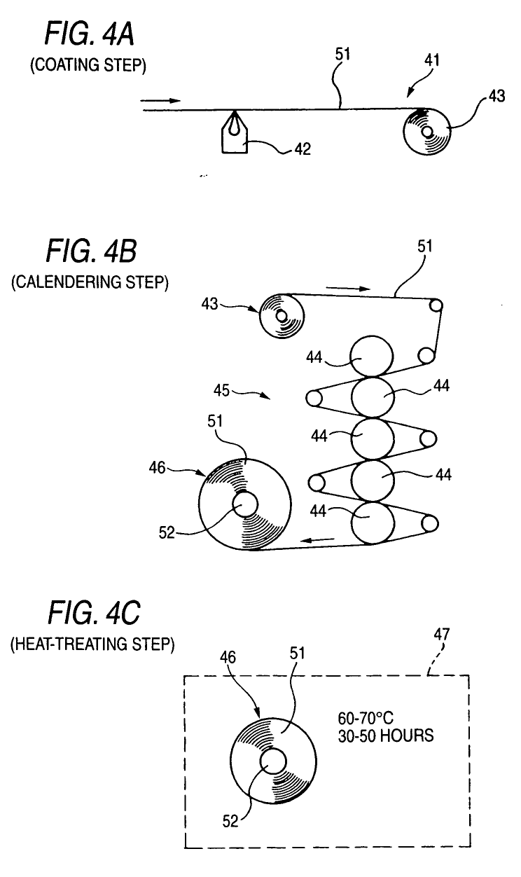

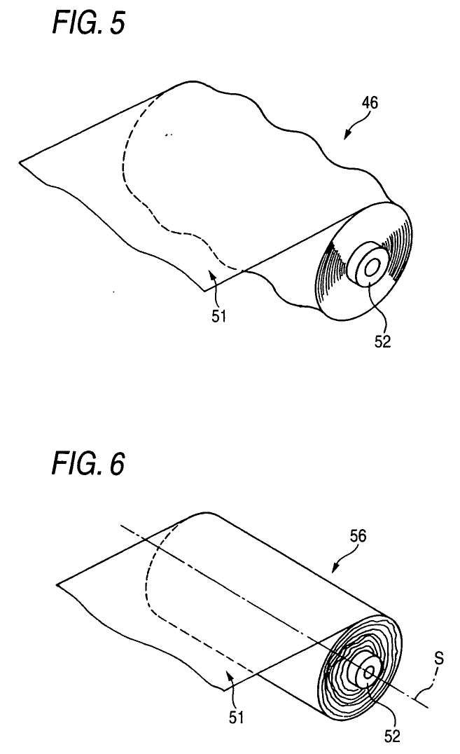

FIG. 3 is a diagram showing the heat-treating step of the support roll in the embodiment. In the heat-treating step in the embodiment, the support roll 10 is subjected to a heat treatment in an environmental atmosphere 21 at a temperature of 50° C. or more. It is preferred that the heat treatment is carried out in an environmental atmosphere 21 at a temperature in a range of from 50 to 120° C. for a period of from 1 to 50 hours.

Further, the method for producing a magnetic recording medium according to the invention is applied not only to a support roll before subjecting to a slitting step but also to a pancake thereof which has been slit with a prescribed width in the longitudinal direction upon the slitting step.

Examples of a magnetic recording medium that can be obtained by the method for producing a magnetic recording medium according to the invention include a magnetic tape. The applicable field of the magnetic tape is not particularly limited, and the advantages of the invention can be obtained by applying, for example, to a magnetic tape cartridge used for backup of computer data.

The magnetic tape herein basically means one having such a structure that a magnetic layer is provided on one surface of a support, and a backcoat layer is provided on the other surface of the support, which includes, for example, a magnetic tape having a nonmagnetic layer between the support and the magnetic layer.

As the support, materials having been conventionally used as a support of a magnetic tape can be used, and a nonmagnetic material is particularly preferably used. Examples thereof include synthetic resin films including a polyester compound (such as polyethylene terephthalate (PET), polyethylene naphthalate (PEN), a mixture of polyethylene terephthalate and polyethylene naphthalate, and a polymer containing an ethylene terephthalate component and an ethylene naphthalate component), a polyolefin compound (such as polypropylene), a cellulose derivative (such as cellulose diacetate and cellulose triacetate), polycarbonate, polyamide (particularly, polyamide and aramid), and polyimide (particularly, wholly aromatic polyimide). Among these, polyethylene terephthalate (PET), polyethylene naphthalate (PEN), aromatic polyamide and aramid are preferably used. The thickness of the support is not particularly limited, and is preferably from 2 to 8 μm, more preferably from 3 to 8 μm, and particularly preferably from 3 to 7 μm.

The magnetic layer is basically formed of ferromagnetic powder and a binder. In general, the magnetic layer further contains a lubricant, carbon black as electroconductive powder, and an abrasive. Examples of the ferromagnetic powder include γ-Fe_{z}O₃, Fe₃O₄, FeOₓ (where x is from 1.33 to 1.5), CrO₂, Co-containing γ-Fe₂O₃, Co-containing FeOₓ (where x is from 1.33 to 1.5), ferromagnetic metallic powder, and tabular hexagonal ferrite powder. As the ferromagnetic powder in the invention, ferromagnetic metallic powder and tabular hexagonal ferrite powder are preferably used, and ferromagnetic metallic powder is particularly preferably used.

The particles of the ferromagnetic metallic powder preferably have a specific surface area of from 30 to 70 m²/g and a crystallite size of from 50 to 300 Å obtained by the X-ray diffractiometry. In the case where the specific surface area is too small, the medium cannot deal with high density recording, and in the case where it is too large, sufficient dispersion cannot be attained to fail to form a magnetic layer having a smooth surface, which brings about failure of high density recording. The ferromagnetic metallic powder necessarily contains at least Fe, and specifically a metallic elementally substance or an alloy including Fe, Fe—Co, Fe—Ni, Fe—Zn—Ni and Fe—Ni—Co. As the magnetic characteristics of the ferromagnetic metallic powder, the saturation magnetization (as) thereof is generally 110 emu/g or more, and preferably from 120 to 170 emu/g, for attaining a high recording density. The coercive force (Hc) is generally from 800 to 3,000 oersted (Oe), and preferably from 1,500 to 2,500 Oe. The long axis diameter of the powder (i.e., the average particle diameter) obtained by observation with a transmission electron microscope is generally 0.5 μm or less, and preferably from 0.01 to 0.3 μm, and the aspect ratio (long axis diameter/short axis diameter, acicular ratio) is generally from 5 to 20, and preferably from 5 to 15. In order to improve further the characteristics, there are cases where a substance including a non-metallic element, such as B, C, Al, Si and P, and a salt and an oxide thereof are added thereto. An oxide layer is generally formed on the surface of the particles of the metallic powder for improving chemical stability.

The tabular hexagonal ferrite powder generally has a specific surface area of from 25 to 65 m²/g, a tabular ratio (tabular diameter/tabular thickness) of from 2 to 15, and a tabular diameter of from 0.02 to 1.0 μm. The tabular hexagonal ferrite powder fails to attain high density recording in the case where it has a too large or too small particle size because of the same factors as in the ferromagnetic metallic powder. The tabular hexagonal ferrite powder is a ferromagnetic material in the form of a tabular shape and having an easy magnetization axis in the direction perpendicular to the tabular surface. Specific examples thereof include barium ferrite, strontium ferrite, lead ferrite, calcium ferrite and a cobalt-substituted material of these ferrite materials. Among these, a cobalt-substituted material of barium ferrite and a cobalt-substituted material of strontium ferrite are preferred. The tabular hexagonal ferrite powder used in the invention may contain an element, such as In, Zn, Ge, Nb and V, for improving the characteristics depending on necessity. As the magnetic characteristics of the tabular hexagonal ferrite powder, the saturation magnetization (as) thereof is generally 50 emu/g or more, and preferably 53 emu/g or more, for attaining a high recording density. The coercive force (Hc) is generally from 700 to 2,000 oersted (Oe), and preferably from 900 to 1,600 Oe.

The ferromagnetic powder preferably has a water content of from 0.01 to 2% by weight. The water content thereof is preferably optimized for the species of the binder. The pH of the ferromagnetic powder is preferably optimized for the binder used in combination, and the pH is generally in a range of from 4 to 12, and preferably in a range of from 5 to 10. The ferromagnetic powder maybe subjected to a surface treatment with Al, Si, P or an oxide of these elements depending on necessity. The using amounts of the element or oxide in the case where the surface treatment is carried out is generally from 0.1 to 10% by weight based on the amount of the ferromagnetic powder. The surface treatment can suppress adsorption of a lubricant, such as a fatty acid, to 100 mg/m² or less. There are cases where the ferromagnetic powder contains a soluble inorganic ion, such as Na, Ca, Fe, Ni and Sr, but there is no influence on the characteristics unless the content thereof exceeds 5,000 ppm.

The lubricant is exuded on the surface of the magnetic layer to relax friction on the surface of the magnetic layer with a magnetic head, and guide poles and cylinders in a tape drive, so as to maintain the sliding state between them smooth. Examples of the lubricant include a fatty acid and a fatty acid ester. Examples of the fatty acid include an aliphatic carboxylic acid, such as acetic acid, propionic acid, octanoic acid, 2-ethylhexanoic acid, lauric acid, myristic acid, stearic acid, palmitic acid, behenic acid, arachidic acid, oleic acid, linoleic acid, linolenic acid, elaidic acid and palmitoleic acid, and mixtures thereof.

Examples of a fatty acid ester include various kinds of ester compounds, such as butyl stearate, sec-butyl stearate, isopropyl stearate, butyl oleate, amyl stearate, 3-methylbutyl stearate, 2-ethylhexyl stearate, 2-hexyldecyl stearate, butyl palmitate, 2-ethylhexyl myristate, a mixture of butyl stearate and butyl palmitate, oleyl oleate, butoxyethyl stearate, 2-butoxy-1-propyl stearate, a compound obtained by acylating dipropylene glycol monobutyl ether with stearic acid, diethylene glycol dipalmitate, a compound obtained by acylating hexamethylenediol with myristic acid, and glycerin oleate. These compounds may be used solely or in combination. The content of the lubricant is generally from 0.2 to 20 parts by weight, and preferably from 0.5 to 10 parts by weight, per 100 parts by weight of the ferromagnetic powder contained in the magnetic layer.

The carbon black is added for various purposes, such as reduction of the surface electric resistance (Rs) and the dynamic friction coefficient (μ_{κ} value) of the magnetic layer, improvement of the running durability of the magnetic layer, and maintenance of the smooth surface property of the magnetic layer. The carbon black preferably has an average particle diameter of from 3 to 350 nm, and more preferably from 10 to 300 nm. The specific surface area thereof is preferably from 5 to 500 m²/g, and more preferably from 50 to 300 m²/g. The DBP oil absorbing amount thereof is preferably from 10 to 1,000 mL per 100 g, and more preferably from 50 to 300 mL per 100 g. The pH thereof is preferably from 2 to 10, the water content thereof is preferably from 0.1 to 10%, and the tap density thereof is preferably from 0.1 to 1 g/cc.

The carbon black may be those obtained by various methods. Examples of the carbon black that can be used herein include furnace black, thermal black, acetylene black, channel black and lamp black. Specific examples of commercially available products of the carbon black include BLACKPEARLS 2000, 1300, 1000, 900, 800 and 700, and VALCAN XC-72 (all produced by Cabot oil & Gas Corp.), #35, #50, #55, #60 and #80 (all produced by Asahi Carbon Co., Ltd.), #3950B, #3750B, #3250B, #2400B, #2300B, #1000, #900, #40, #30 and #10B (all produced by Mitsubishi Chemical Corp.) CONDUCTEX SC and RAVEN 150, 50, 40 and 15 (all produced by Columbia Carbon, Inc.), and Ketchen Black EC, Ketchen Black ECDJ-500 and Ketchen Black ECDJ-600 (all produced by Lion Akzo Co., Ltd.). The addition amount of the carbon black is generally from 0.1 to 30 parts by weight, and preferably from 0.2 to 15 parts by weight, per 100 parts by weight of the ferromagnetic powder.

Examples of the abrasive include fused alumina, silicon carbide, chromiumoxide (Cr2O3), corundum, artificial corundum, diamond, artificial diamond, garnet and emery (main components: corundum and magnetite). The abrasive generally has a Mohs hardness of 5 or more, and preferably 6 or more, and preferably has an average particle diameter of from 0.05 to 1 μm, and more preferably from 0.2 to 0,8 μm. The addition amount of the abrasive is generally from 3 to 25 parts by weight, and preferably from 3 to 20 parts by weight, per 100 parts by weight of the ferromagnetic powder.

Examples of the binder in the magnetic layer include a thermoplastic resin, a thermosetting resin, a reactive resin and a mixture thereof. Examples of the thermoplastic resin include a polymer and a copolymer containing, as a constitutional unit, vinyl chloride, vinyl acetate, vinyl alcohol, maleic acid, acrylic acid, an acrylate ester, vinylidene chloride, acrylonitrile, methacrylic acid, a methacrylate ester, styrene, butadiene, ethylene, vinyl butyral, vinyl acetal and vinyl ether. Examples of the copolymer include a vinyl chloride-vinyl acetate copolymer, a vinyl chloride-vinylidene chloride copolymer, a vinyl chloride-acrylonitrile copolymer, an acrylate ester-acrylonitrile copolymer, an acrylate ester-vinylidene chloride copolymer, an acrylate ester-styrene copolymer, a methacrylate ester-acrylonitrile copolymer, a methacrylate ester-vinylidene chloride copolymer, a methacrylate ester-styrene copolymer, a vinylidene chloride-acrylonitrile copolymer, a butadiene-acrylonitrile copolymer, a styrene-butadiene copolymer and a chlorovinyl ether-acrylate ester copolymer.

In addition to the aforementioned polymers and copolymers, a polyamide resin, a cellulose resin (such as cellulose acetate butyrate, cellulose diacetate, cellulose propionate and nitrocellulose), polyvinyl fluoride, a polyester resin, a polyurethane resin and various kinds of rubber.

Examples of the thermosetting resin and the reactive resin include a phenol resin, an epoxy resin, a polyurethane curable resin, a urea resin, a melamine resin, an alkyd resin, an acrylic reactive resin, a formaldehyde resin, a silicone resin, an epoxy-polyamide resin, a mixture of a polyester resin and a polyisocyanate prepolymer, a mixture of polyesterpolyol and polyisocyanate, and a mixture of polyurethane and polyisocyanate.

Examples of the polyisocyanate include a isocyanate compound, such as tolylene diisocyanate, 4,4′-diphenylmethane diisocyanate, hexamethylene diisocyanate, xylylene diisocyanate, naphthylene-1,5-diisocyanate, o-toluidine diisocyanate, isophorone diisocyanate and triphenylmethane tiriisocyanate, a reaction product of the isocyanate compound and a polyalcohol, and a polyisocyanate obtained by condensation of the isocyanate compound.

Examples of the polyurethane resin include known resins having such a structure as polyester polyurethane, polyether polyurethane, polyether polyester polyurethane, polycarbonate polyurethane, polyester polycarbonate polyurethane and polycaprolactone polyurethane.

The binder of the magnetic layer in the invention is preferably a combination of at least one resin selected from a vinyl chloride resin, a vinyl chloride-vinyl acetate copolymer, a vinyl chloride-vinyl acetate-vinyl alcohol copolymer, a vinyl chloride-vinyl acetate-maleic anhydride copolymer and nitrocellulose, with a polyurethane resin, or a combination further containing a polyisocyanate.

It is preferred that the binder contains at least one polar group selected from —COOM, —SO₃M, —OSO₃M, —P═O(OM)₂, —O—P═O(MO)₂ (wherein M represents a hydrogen atom or an alkali metal salt group), —OH, —NR₂, —N⁺R₃ (wherein R represents a hydrocarbon group), an epoxy group, —SH and —CN, introduced through copolymerization or addition reaction, depending on necessity, for obtaining excellent dispersion property and excellent durability of the layer to be obtained. It is preferred that the polar group is introduced in the binder in an amount of from 10⁻¹ to 10⁻⁸ mole/g, and more preferably from 10⁻² to 10⁻⁶ mole/g.

The binder of the magnetic layer is generally used in an amount of from 5 to 50 parts by weight, and preferably from 10 to 30 parts by weight, per 100 parts by weight of the ferromagnetic powder. In the case where a vinyl chloride resin, a polyurethane resin and a polyisocyanate are used in combination as the binder of the magnetic layer, it is preferred that in the total binder, the amount of the vinyl chloride resin is from 5 to 70% by weight, the amount of the polyurethane resin is from 2 to 50% by weight, and the amount of the polyisocyanate is from 2 to 50% by weight.

A coating composition for forming the magnetic layer of the magnetic tape may contain a dispersing agent for improving dispersion state of the magnetic powder in the binder. The coating composition may further contain, depending on necessity, a plasticizer, electroconductive particles (antistatic agent) other than carbon black, and an antifungal agent. Examples of the dispersing agent include a fatty acid having from 12 to 18 carbon atoms (RCOOH, wherein R represent an alkyl or alkenyl group having from 11 to 17 carbon atoms), such as caprylic acid, capric acid, lauric acid, myristic acid, palmitic acid, stearic acid, behenic acid, oleic acid, elaidic acid, linoleic acid, linolenic acid and stearolic acid, a metallic soap of the aforementioned fatty acid with an alkali metal or an alkaline earth metal, a fluorine-compound derived from the aforementioned fatty acid ester, an amide of the aforementioned fatty acid, polyalkylene oxide alkylphosphate ester, lecithin, trialkylpolyolefin oxyquaternary ammonium salt (wherein the alkyl group has from 1 to 5 carbon atoms, and examples of the olefin include ethylene and propylene), a sulfate salt, and copper phthalocyanine. These compounds may be used solely or in combination. The dispersing agent is generally added in an amount of from 0.5 to 20 parts by weight per 100 parts by weight of the binder in the magnetic layer.

The backcoat layer will be then described. The backcoat layer is preferably formed of carbon black and a binder. The backcoat layer preferably further contains inorganic powder and a lubricant. The carbon black is preferably a mixture of two kinds thereof having average particle diameters different from each other. In this case, it is preferred to use a fine particle carbon black having an average particle diameter of from 10 to 20 nm and coarse particle carbon black having an average particle diameter of from 230 to 300 nm in combination. In general, the addition of the fine particle carbon black can lower the surface electric resistance and the light transmittance of the backcoat layer. Some types of magnetic recording devices utilize the light transmittance of the tape as operation signals, and in such devices, the addition of the fine particle carbon black is effective. The fine particle carbon black generally has capability of retaining a liquid lubricant to contribute to reduction in friction coefficient upon using a lubricant in combination. The coarse particle carbon black having a particle diameter of from 230 to 300 nm has a function as a solid lubricant and reduces the contact area on the surface of the backcoat layer by forming fine protrusions thereon to contribute to reduction in friction coefficient.

Examples of commercially available products of the fine particle carbon black include RAVEN 2000B (18 nm) and RAVEN 1500B (17 nm) (all produced by Columbia Carbon, Inc.), BP 800 (17 nm) (produced by Cabot Oil & Gas Corp.), PRINTEX 90 (14 nm), PRINTEX 95 (15 nm), PRINTEX 85 (16 nm) and PRINTEX 75 (17 nm) (all produced by Degussa AG) and #3950 (16 nm) (produced by Mitsubishi Chemical Corp.). Examples of commercially available products of the coarse carbon black include Thermal Black (270 nm) (produced by Kan Karb Corp.) and RAVEN MTP (275 nm) (produced by Columbia Carbon, Inc.).

Two kinds of carbon black having different average particle diameters are used in the backcoat layer, the ratio of the fine particle carbon black having an average particle diameter of from 10 to 20 nm to the coarse particle carbon black having an average particle diameter of from 230 to 300 nm (fine carbon black/coarse carbon black) is preferably from 98/2 to 75/25, and more preferably from 95/5 to 85/15. The content of the carbon black in total in the backcoat layer is generally from 30 to 110 parts by weight, and preferably from 50 to 90 parts by weight, per 100 parts by weight of the binder.

The inorganic powder is preferably a mixture of two kinds thereof that are different in hardness from each other. Specifically, soft inorganic powder having a Mohs hardness of from 3 to 4.5 and hard inorganic powder having a Mohs hardness of from 5 to 9 are preferably used in combination. The addition of the soft inorganic powder having a Mohs hardness of from 3 to 4.5 stabilize the friction coefficient on repeated running. The inorganic powder having a hardness within the range does not abrade the sliding guide poles. The average particle diameter of the soft inorganic powder is preferably in a range of from 30 to 50 nm. Examples of the soft inorganic powder having a Mohs hardness of from 3 to 4.5 include calcium sulfate, calcium carbonate, calcium silicate, barium sulfate, magnesium carbonate, zinc carbonate and zinc oxide. These may be used solely or in combination of two or more kinds of them. Among these, calcium carbonate is preferred. The content of the soft inorganic powder in the backcoat layer is preferably from 10 to 140 parts by weight, and more preferably from 35 to 100 parts by weight, per 100 parts by weight of the carbon black.

The addition of the hard inorganic powder having a Mohs hardness of from 5 to 9 improve the strength of the backcoat layer to improve the running durability. The use of the hard inorganic powder in combination with carbon black provides such a strong backcoat layer that is suppressed in deterioration upon repeated sliding. The addition of the inorganic powder imparts moderate abrasion power to the backcoat layer to reduce attachment of shaving dusts to tape guide poles. The hard inorganic powder preferably has an average particle diameter of from 80 to 250 nm, and more preferably from 100 to 120 nm.

Examples of the hard inorganic powder having a Mohs hardness of from 5 to 9 include α-iron oxide, α-alumina and chromium oxide (Cr₂O₃). These kinds of powder may be used solely or in combination. Among these α-iron oxide and α-alumina are preferred. The content of the hard inorganic powder is generally from 3 to 30 parts by weight, and preferably from 3 to 20 parts by weight, per 100 parts by weight of the carbon black.

The backcoat layer may contain a lubricant. The lubricant can be appropriately selected from those lubricants described for the magnetic layer. The lubricant is generally added to the backcoat layer in an amount of from 1 to 5 parts by weight per 100 parts by weight of the binder. The backcoat layer may contain those dispersing agents described for the magnetic layer. The addition amount of the dispersing agent may be the same as the addition amount thereof to the magnetic layer.

The binder in the backcoat layer may be those binders described for the magnetic layer. Examples of the binder that can be used in the backcoat layer include a nitrocellulose resin, a polyurethane resin, a polyester resin and a polyisocyanate as a curing agent. The amount of the binder in the backcoat layer is generally from 5 to 250 parts by weight, and preferably from 10 to 200 parts by weight, per 100 parts by weight of the carbon black.

The magnetic tape of the invention may have such a structure that a nonmagnetic layer is provided between a support and a magnetic layer. In other words, the invention may be such a magnetic tape that has a nonmagnetic layer and a magnetic layer on one surface of a support, and a backcoat layer on the other surface of the support. The nonmagnetic layer is such a layer that is substantially nonmagnetic and contains nonmagnetic powder and a binder, The nonmagnetic layer is necessarily nonmagnetic for preventing the electromagnetic conversion characteristics of the magnetic layer thereon from being influenced therefrom, but there is no particular problem in the case where magnetic powder is contained in such a small amount that does not influence on the electromagnetic conversion characteristics of the magnetic layer. The nonmagnetic layer generally contains a lubricant in addition to the aforementioned components.

Examples of the nonmagnetic powder used in the nonmagnetic layer include nonmagnetic inorganic powder and carbon black. The nonmagnetic inorganic powder is preferably relatively hard and preferably has a Mohs hardness of 5 or more, and more preferably 6 or more. Examples of the nonmagnetic inorganic powder include α-alumina, β-alumina, γ-alumina, silicon carbide, chromium oxide, cerium oxide, α-iron oxide, corundum, silicon nitride, titanium carbide, titanium dioxide, silicon dioxide, boron nitride, zinc oxide, calcium carbonate, calcium sulfate and barium sulfate. These may be used solely or in combination. Among these, titanium dioxide, α-alumina, α-iron oxide and chromiumoxide are preferred. The nonmagnetic inorganic powder preferably has an average particle diameter of from 0.01 to 1.0 μm, preferably from 0.01 to 0.5 μm, and particularly preferably from 0.02 to 0.1 μm.

The carbon black is added for imparting electroconductivity to the magnetic layer to prevent static charge and for securing the smooth surface property of the magnetic layer formed on the nonmagnetic layer. The carbon black used in the nonmagnetic layer may be those kinds of carbon black described for the magnetic layer, provided that the carbon black used in the nonmagnetic layer preferably has an average particle diameter of 35 nm or less, and more preferably from 10 to 35 nm. The addition amount of the carbon black is generally from 3 to 20 parts by weight, preferably from 4 to 18 parts by weight, and more preferably from 5 to 15 parts by weight, per 100 parts by weight in total of the nonmagnetic powder in the nonmagnetic layer.

The lubricant may be the fatty acids and the fatty acid esters described for the magnetic layer. The addition amount of the lubricant is generally from 0.2 to 20 parts by weight per 100 parts by weight in total of the nonmagnetic powder in the nonmagnetic layer.

The binder in the nonmagnetic layer may be the binders described for the magnetic layer. The binder is generally used in an amount of from 5 to 50 parts by weight, and preferably from 10 to 30 parts by weight, per 100 parts by weight of the nonmagnetic powder in the nonmagnetic layer. In the case where a vinyl chloride resin, a polyurethane resin and a polyisocyanate are used in combination as the binder of the nonmagnetic layer, it is preferred that in the total binder, the amount of the vinyl chloride resin is from 5 to 70% by weight, the amount of the polyurethane resin is from 2 to 50% by weight, and the amount of the polyisocyanate is from 2 to 50% by weight. The nonmagnetic layer may contain those arbitrary components that can be added to the magnetic layer.

The magnetic tape of the invention can be produced in the following manner. A coating composition for forming the magnetic layer (coating compositions for the magnetic layer and the nonmagnetic layer in the structure having the nonmagnetic layer provided) and a coating composition for forming the backcoat layer are prepared. The coating composition for the magnetic layer is coated on one surface of a support web in a long strip form to provide the magnetic layer. The coating composition for the backcoat layer is coated on the other surface of the support to provide the backcoat layer. The support is then dried to obtain a magnetic recording web in a long strip form. Thereafter, the web is subjected to a calendering treatment and then slit in the longitudinal direction to obtain a magnetic tape. The surface of the magnetic layer of the resulting magnetic tape is rubbed with the aforementioned molded article to effect the treatment according to the invention, whereby the magnetic tape is completed.

In the case of the magnetic tape having the nonmagnetic layer, the methods for forming the magnetic layer and the nonmagnetic layer are not particularly limited, and the layers are preferably coated by a coating method of the so-called wet-on-wet system, in which after coating a coating composition for the nonmagnetic layer, a coating composition for the magnetic layer is coated thereon while the coated layer of the nonmagnetic layer is in a wet state.

Examples of coating methods according to the wet-on-wet system include:

(1) a method, in which the nonmagnetic layer is first formed on the support by using a gravure coating apparatus, a roll coating apparatus, a blade coating apparatus or an extrusion coating apparatus, and in the state where the nonmagnetic layer is in a wet state, the magnetic layer is coated with a support-pressurizing type extrusion coating apparatus (as described in JP-A-60-238179, JP-B-1-46186 and JP-A-2-265672),

(2) a method, in which the magnetic layer and the nonmagnetic layer are coated substantially simultaneously on the support by using such a coating apparatus that has a single coating heat having two slits for coating compositions (as described in JP-A-63-88080, JP-A-2-17921 and JP-A-2-265672), and

(3) a method, in which the magnetic layer and the nonmagnetic layer are coated substantially simultaneously on the support by using an extrusion coating apparatus equipped with a backup roller (as described in JP-A-2-174965). The magnetic layer and the nonmagnetic layer are preferably formed by utilizing the simultaneous multilayer coating method.

There is such a tendency in the magnetic tape that the surface of the backcoat layer is transferred to the surface of the magnetic layer in the state where the tape is wound. Therefore, the surface of the backcoat layer also preferably has relatively high smoothness. The surface of the backcoat layer of the magnetic tape is preferably adjusted to have a surface roughness Ra (center line roughness with a cutoff length of 0.08 mm) in a range of from 0.003 to 0.060 μm. The surface roughness can generally be adjusted with the material, the surface property and the pressure of the calender roll used in the surface-treating step by calendering.

In a magnetic tape produced by the production method of the invention, which has a single layer structure, i.e., a magnetic layer on one surface of a support and a backcoat layer on the other surface of the support, the magnetic layer preferably has a thickness in a range of from 1.0 to 3.0 μm, and more preferably from 1.5 to 2.5 μm. The total thickness of the magnetic tape having the aforementioned structure is preferably in a range of from 4.0 to 12.0 μm, and more preferably from 4.0 to 10.0 μm. The thickness of the backcoat layer is preferably in a range of from 0.1 to 1.0 μm, and more preferably from 0.2 to 0.8 μm.

The magnetic layer of the magnetic tape having the nonmagnetic layer preferably has a thickness in a range of from 0.01 to 1.0 μm, and more preferably from 0.05 to 0.5 μm. The thickness of the nonmagnetic layer is preferably in a range of from 0.01 to 3.0 μm, and more preferably from 0.5 to 2.5 μm. The ratio in thickness of the magnetic layer to the nonmagnetic layer is preferably in a range of from ½ to 1/15, and more preferably from ⅕ to 1/12. The total thickness of the magnetic tape having a structure with the nonmagnetic layer and the thickness of the backcoat layer of the magnetic tape are preferably in the same ranges as those in the aforementioned magnetic tape having the single layer structure.

### EXAMPLE

The invention will be described in detail by comparing examples and comparative examples in the following experiment.

In the experiment, a support having a thickness of 9 μm having a magnetic layer formed thereon was wound on winding cores shown in Table 1 below, and magnetic tapes (slit supports) as samples were produced in the same process under the same conditions. The resulting magnetic tapes were tested for occurrence of dropout (DO) by making them follow a magnetic head, which is not shown in the figure. The value obtained by the expression 54,000/D+0.007 L+10⁶α is designated as P value. The P value is an index of the intensity on winding the support.

In the experiment, one of winding cores having diameters of 300, 400 and 480 mm, respectively, was used, and the material thereof was one of aluminum (Al) and CFRP. The winding core had a linear expansion coefficient of 2.30×10⁻⁵ or 2.00×10⁻⁶. The length of the support (referred to as the processed length in Table 1) wound on the winding core was 4,000, 8,000 or 12,000 m. In the experiment, cases where dropout occurs is expressed by B, and cases where no dropout occurs is expressed by A. The results obtained are shown in Table 1.

TABLE 1

| | | | Linear | | | |
|---|---|---|---|---|---|---|
| | Diameter D of | | expansion | | | |
| | winding core | Material of | coefficient σ | Processed | | |
| | (mm) | winding core | (per ° C.) | length L (m) | P value | DO |
| Comparative | 300 | Al | 2.30 × 10⁻⁵ | 4,000 | 231 | B |
| Example 1 | | | | | | |
| Comparative | 300 | Al | 2.30 × 10⁻⁵ | 8,000 | 259 | B |
| Example 2 | | | | | | |
| Comparative | 300 | Al | 2.30 × 10⁻⁵ | 12,000 | 287 | B |
| Example 3 | | | | | | |
| Example 1 | 400 | Al | 2.30 × 10⁻⁵ | 4,000 | 186 | A |
| Comparative | 400 | Al | 2.30 × 10⁻⁵ | 8,000 | 214 | B |
| Example 4 | | | | | | |
| Comparative | 400 | Al | 2.30 × 10⁻⁵ | 12,000 | 242 | B |
| Example 5 | | | | | | |
| Example 2 | 480 | Al | 2.30 × 10⁻⁵ | 4,000 | 164 | A |
| Example 3 | 480 | Al | 2.30 × 10⁻⁵ | 8,000 | 192 | A |
| Comparative | 480 | Al | 2.30 × 10⁻⁵ | 12,000 | 220 | B |
| Example 6 | | | | | | |
| Comparative | 300 | CFRP | 2.00 × 10⁻⁶ | 4,000 | 210 | B |
| Example 7 | | | | | | |
| Comparative | 300 | CFRP | 2.00 × 10⁻⁶ | 8,000 | 238 | B |
| Example 8 | | | | | | |
| Comparative | 300 | CFRP | 2.00 × 10⁻⁶ | 12,000 | 266 | B |
| Example 9 | | | | | | |
| Example 4 | 400 | CFRP | 2.00 × 10⁻⁶ | 4,000 | 165 | A |
| Example 5 | 400 | CFRP | 2.00 × 10⁻⁶ | 8,000 | 193 | A |
| Comparative | 400 | CFRP | 2.00 × 10⁻⁶ | 12,000 | 221 | B |
| Example 10 | | | | | | |
| Example 6 | 480 | CFRP | 2.00 × 10⁻⁶ | 4,000 | 143 | A |
| Example 7 | 480 | CFRP | 2.00 × 10⁻⁶ | 8,000 | 171 | A |
| Example 8 | 480 | CFRP | 2.00 × 10⁻⁶ | 12,000 | 199 | A |

As shown in Table 1, the support rolls having a P value exceeding 200 suffered dropout of magnetic tapes, but the support rolls having a P value of 200 or less provided magnetic tapes without dropout.

What is claimed is:

1. A method for producing a magnetic recording medium comprising a step of winding a support on a winding core to form a support roll, the following relationship being satisfied:
200≧54,000/D+0.007 L+10⁶α
wherein D represents an outer diameter (mm) of the winding core, L represents a wound length (m) of the support, and α represents a linear expansion coefficient (per ° C.) in a circumferential direction of the winding core.

2. The method according to claim 1, wherein the winding core comprises a material having a linear expansion coefficient of 5×10⁻⁶ or less, and a Young's modulus in the circumferential direction of 8,000 kg/mm² or more.

3. The method according to claim 1, wherein the winding core comprises CFRP.

4. The method according to claim 1, further comprising a step of subjecting the winding roll to a heat treatment in an environmental atmosphere having a temperature of 50° C. or more.

5. The method according to claim 1, further comprising a step of subjecting the winding roll to a heat treatment in an environmental atmosphere having a temperature of 50° C. to 120° C. for 1 to 50 hours.

6. The method according to claim 1, further comprising:
a coating step of coating and forming a magnetic layer containing ferromagnetic powder and a binder on one surface of the support in a strip form;
a coating step of coating and forming a backcoat layer on a surface of the support opposite to the magnetic layer;
a calendering step of subjecting the support having the magnetic layer and the backcoat layer formed thereon to a calendering treatment;
a heat-treating step of subjecting the calendered support to a heat treatment; and
a slitting step of slitting the calendered support in the longitudinal direction.

7. The method according to claim 6, further comprising a servo step after the slitting step.

8. A magnetic recording medium produced by the method according to claim 1.

9. The magnetic recording medium according to claim 8, wherein the magnetic recording medium comprises a recording layer on one surface thereof and a backcoat layer on the other surface thereof.

10. The magnetic recording medium according to claim 9, wherein the magnetic recording medium further comprises a nonmagnetic recording layer between the support and the magnetic layer.

11. A support roll comprising a winding core and a support wound around the winding core, the following relationship being satisfied:
200≧54,000/D+0.007 L+10⁶α
wherein D represents an outer diameter (mm) of the winding core, L represents a wound length (m) of the support, and a represents a linear expansion coefficient (per ° C.) in a circumferential direction of the winding core.

12. The support roll according to claim 11, wherein the outer diameter is 400 mm or more.

13. The support roll according to claim 11, wherein the support has a thickness of 5 μm or more.

14. The support roll according to claim 11, wherein the winding core has a cylindrical shape.

15. The support roll according to claim 11, wherein the wound length is 1000 m to 12000 m.

16. The support roll according to claim 11, wherein the winding core is made of a material having the linear expansion coefficient of 5×10⁻⁶ or less and a Young's modulus in the circumferential direction of 8,000 kg/mm² or more.

17. The support roll according to claim 16, wherein the material is CFRP.
